(19) United States
(12) Patent Application Publication
(10) Pub. No.: US 2012/0038666 A1
(43) Pub. Date: Feb. 16, 2012

(54) METHOD FOR CAPTURING AND DISPLAYING IMAGE DATA OF AN OBJECT

(75) Inventors: Christian Evers, Kirchheim (DE); Gerd Hechtfischer, Vaterstetten (DE); Andreas Schiessl, Munich (DE); Ralf Juenemann, Munich (DE); Andreas Paech, Munich (DE); Olaf Ostwald, Munich (DE); Marcus Schreckenberg, Freising (DE); Georg Schummers, Munich (DE); Alexander Rossmaith, Germering (DE)

(73) Assignees: TomTec Imaging Systems GmbH, Unterschleissheim (DE); Rohde & Schwarz GmbH & Co. KG, Munich (DE)

(21) Appl. No.: 13/266,096

(22) PCT Filed: Apr. 14, 2010
(86) PCT No.: PCT/EP2010/002298

§ 371 Date: Oct. 24, 2011

(30) Foreign Application Priority Data
Apr. 23, 2009 (DE) 10 2009 018 702.2
Jul. 27, 2009 (DE) 10 2009 034 819.0

(51) Int. Cl. G09G 5/377

(52) U.S. Cl. 345/629

(57) ABSTRACT

A method for detecting and displaying image data of at least one object with reference to a human or animal body is provided with the following method steps: detecting a spatial structure and position of the object through a physical space detection and generating image data of the object on the basis of this detection, projecting the image data onto an artificial body, which represents the human or animal body, and displaying the object using the image data projected onto the artificial body.

### CROSS-REFERENCE TO RELATED APPLICATION

The present application is a national phase application of PCT Application No. PCT/EP2010/002298, filed on Apr. 14, 2010, and claims priority to German Application No. DE 10 2009 018 702.2, filed on Apr. 23, 2009, and German Application No. DE 10 2009 034 819.0, filed on Jul. 27, 2009, the entire contents of which are herein incorporated by reference.

### BACKGROUND OF THE INVENTION

1. Field of the Invention

The invention relates to a method for detecting and displaying image data of one or more objects with reference to a human or animal body.

2. Discussion of the Background

Metal detectors are conventionally used for security monitoring of persons, for example, at airports. However, these are not capable of detecting objects not made of metal, for example, ceramic knives, firearms or explosives manufactured from ceramic materials. While passenger luggage is generally analyzed using x-ray radiation, an ionising x-ray radiation can only be used to a limited extent for monitoring passengers themselves because of the health hazard.

Accordingly, in recent years, systems based on microwave radiation have been developed, which allow a rapid and reliable security monitoring of persons, for example, at airports. One such system based on microwave radiation is known, for example, from U.S. Pat. No. 6,965,340 B1. This system is based upon the fact that the objects to be detected have a significantly different dielectric constant by comparison with the surrounding air or by comparison with surrounding textiles, which leads to significant contrasts in the image reproduction. In this context, the detection is implemented down to the skin surface of the persons to be investigated, because skin-tissue with circulating blood has such a high water content that total reflection occurs there. However, clothing made of textiles or leather is penetrated by the microwave radiation without difficulty. Accordingly, objects which are concealed in the textiles or on the body surface can be detected with the system. However, a comprehensive introduction of these systems has so far been unsuccessful because the responsible authorities considered the privacy of the persons under investigation, especially in the facial and genital region, infringed by the image reproduction.

### SUMMARY OF THE INVENTION

Embodiments of the invention provide a method and a device for detecting and displaying image data of an object with reference to a human or animal body in which the image reproduction is abstracted in such a manner that the privacy of the persons to be investigated remains protected.

According to embodiments of the invention, the detected image data are displayed indirectly rather than directly by being projected onto an artificial body which represents the human or animal body.

The artificial body can be a so-called avatar of a form representing a typical human body in an abstract manner, which does in fact provide human characteristics in a similar manner to a computer animation and shows a human being of typical physical stature, but which does not reproduce in concrete terms the person currently under observation. However, the artificial body can also be an even further abstracted body, for example, a cylinder or several cylindrical, conical, truncated conical or spherical bodies on to which the image data are projected. The facial characteristics or other body-typical geometries are distorted in this context to such an extent that the privacy of the person under observation remains protected. The objects to be detected are in fact distorted in a similar manner; however, they are still detected by the system and are still detectable in their coarse structure. In a concrete case of suspicion, individual bodily regions can be selected and de-distorted by applying the inverse distortion method, so that the detected objects can be displayed in their original structure, but only in conjunction with the immediately surrounding bodily regions of the person under observation.

In a particularly advantageous manner, the avatar is not displayed directly but only a wind-off surface of the avatar with the objects projected onto it. Accordingly, a further abstraction of the display of the body surface is achieved. For example, the trunk of the body can be displayed in the form of a trapezium. The arms and legs can be displayed as rectangles. The head region can be displayed as a circle. Individual body regions can be displayed to the observer in an arbitrarily pixelated manner like a puzzle, without the observer being able to allocate the individual parts of the puzzle to the individual regions of the body. If an object to be detected is disposed in a region of the body to be especially protected with regard to the private regions, for example, in the genital region, this is not immediately evident to the observer, because the displayed detail of the body is displayed, on the one hand, extremely small and, on the other hand, is heavily distorted. The privacy of the person under investigation accordingly remains protected. The wind-off surface can also be, for example, a pattern of a virtual clothing.

If the critical object is detected either automatically or through the observation of a monitoring person, the object is preferably displayed not in connection with the image data of the person under observation, but on the avatar, so that the monitoring person of can recognize the body region in which the detected object is disposed, and further targeted investigations can be implemented there. It is also possible only to indicate the position of the object, for example, by a laser pointer. The position of the object can then also be displayed either on screen on the avatar, or the body region can be displayed directly on the person to be investigated through a laser pointer, so that further investigations can be implemented there, for example, through a body search.

It is also possible to re-project the image data projected onto the artificial body, so that the complete image data are shown to the security personnel only if security-relevant objects have actually been found. However, the display can then be limited to the region in which the objects have been found. Accordingly, the transformation used for the projection must be bijective relative to the re-transformation used for the re-projection and therefore provide one-to-one correspondence, that is, the transformation used for the projection must be unambiguous to the extent that the image point, from which a projected starting point originates can be unambiguously reconstructed.

In order to improve data protection further, it is meaningful to use an encryption in the transformation so that the re-transformation is possible only by authorized personnel. An unauthorized data reproduction of the projected image data is therefore not damaging, because an unauthorized third person does not have the key at their disposal. It is also possible to provide the key only to specially authorized members of the control team, who only implement the re-transformation when they are convinced of the danger of the detected objects. In order to prevent misuse, it is also possible to release the re-transformation only if at least two members of the control team have independently from one another come to the conclusion that a security-risk object has been detected.

The method according to the invention is suitable not only for microwave scanners but for every type of image-producing detector, for example, also for x-ray scanners.

Before the actual image transformation, it is meaningful to implement various measures to improve the image quality, for example, a noise suppression or a suppression of low-frequency signal components which are caused by the contour of the human or animal body. It is also meaningful to limit the image processing to a cartoon-like display of outlines.

### BRIEF DESCRIPTION OF THE DRAWINGS

By way of example, the following section describes an exemplary embodiment of the invention in greater detail with reference to the drawings. The drawings are as follows:

FIG. 1 shows a block-circuit diagram of an exemplary embodiment of the device according to the invention;

FIG. 2 shows objects projected onto an avatar;

FIG. 3 shows a simplified wind-off surface of the avatar with the objects projected onto it; and

FIG. 4 shows the avatar with detection markers which indicate the position of the detected objects projected onto it.

### DETAILED DESCRIPTION OF EXEMPLARY EMBODIMENTS OF THE INVENTION

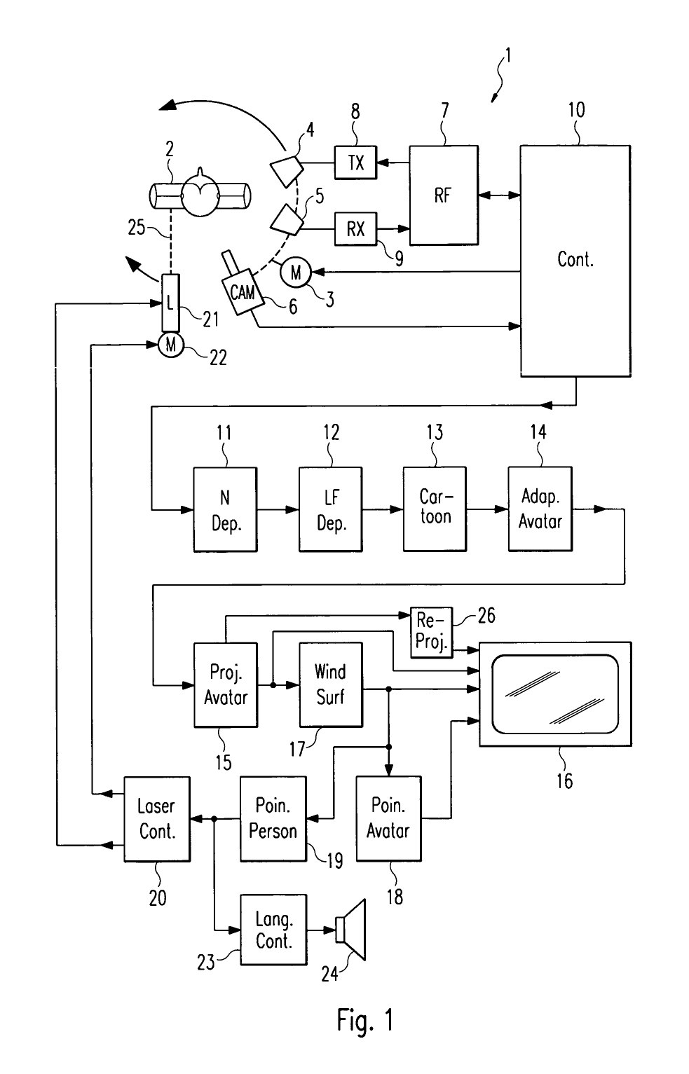

FIG. 1 shows a simplified block-circuit diagram of the device 1 according to the invention. A signal-recording system comprising a transmission antenna 4, a reception antenna 5 and optionally an optical camera 6 can be moved around the person 2 under observation by means of an electric motor 3, preferably a stepped motor. By preference, the signal-recording system can be moved through 360° around the person 2 under observation. This sampling process is preferably implemented in several planes. However, a plurality of antennas can also be arranged distributed in rows or in a matrix in order to scan the person 2 under observation in a parallel manner.

A high-frequency unit 7 is connected via a transmission device 8 to the transmission antenna 4. At the same time, the high-frequency unit 7 is connected via a reception unit 9 to the reception antenna 5. The signal received from the high-frequency unit 7 is routed to a control unit 10, which collates image data from the received signal. The control unit 10 also undertakes the control of the motor 3 and the optical camera 6. If several antennas are provided distributed in the form of a matrix, an adjustment of the transmission antenna 4 and of the reception antenna 5 is not necessary. In each case, one antenna after the other always operates in succession as a transmission antenna and the signal is received by all the other antennas. The motor 3 for spatial adjustment of the arrangement of the antennas 4 and 5 can then be dispensed with.

The invention is not restricted to microwave scanners of this kind, especially terahertz scanners. Other methods, which provide a corresponding data-record volume, that is, data according to modulus and phase for every voxel (discrete spatial element) are suitable provided they allow a three-dimensional surface display of the human or animal body. X-ray scanners using x-ray radiation are also suitable. Scanners, which generate the three-dimensional information only in a secondary manner through corresponding stereo evaluation methods are also covered.

Following this, a corresponding pre-processing of the raw image data generated by the image recording is implemented. The raw image data are preferably initially conditioned in order to improve the image quality. For this purpose, the raw image data are initially routed from the control unit 10 to the noise suppression processor 11, which implements a corresponding noise suppression (noise suppression). Reflections at the contour of the human or animal body generate signal components with low local frequency, which can be filtered out by the filter device 12 in order to suppress these low-frequency signal components. Following this, a generation of one or more feature images for each individual recorded image is preferably implemented. For this purpose, the data (for example, RGB data) of the camera 6 can also be used. This revision is implemented in the image-abstraction processor 13. The result can be, for example, a cartoon-like display of outlines. A cross-fading with the optical RGB data of the camera 6 is also conceivable. A camera with depth imaging, for example, a so-called TOF camera is particularly suitable for the optical measurement of depth information.

Following this, the avatar, that is to say, the standardized model of a human body with spatially limited detail, is preferably matched in the unit 14, which allows only restricted deformations, to the depth map which is supplied by the camera 6. In this context, the avatar is brought into a body position which corresponds to the body position of the person 2 under observation which the latter occupies at precisely the moment of the investigation. This allows the observer of the avatar a better on-screen allocation of any objects which may be detected to the corresponding body parts, because s/he sees the avatar in the same body position as the person under observation.

Following this, the projection of the objects or the feature images with the objects onto the surface of the avatar is implemented in a unit 15. In this context, non-rigid deformations of the feature images may be necessary in the edge regions in order to avoid transitional artefacts. If several measured values for one surface point of the avatar originate from different feature images or several successively implemented measurements, the projection value used can be determined in a different manner. In the simplest case, an averaging, preferably a weighted averaging of the measured values from the different measurements is implemented. However, the selection of the measured value or feature image with optimal presentation of contrast is also conceivable. The optimal feature image depends primarily on the recording angle. If the signal-recording system is moved around the person 2 under observation, there are generally one or more antenna positions in which the relevant image point is reproduced with optimal contrast. The image data of this measurement are then used for this image point, while other image data from other measurements may be used for other image points.

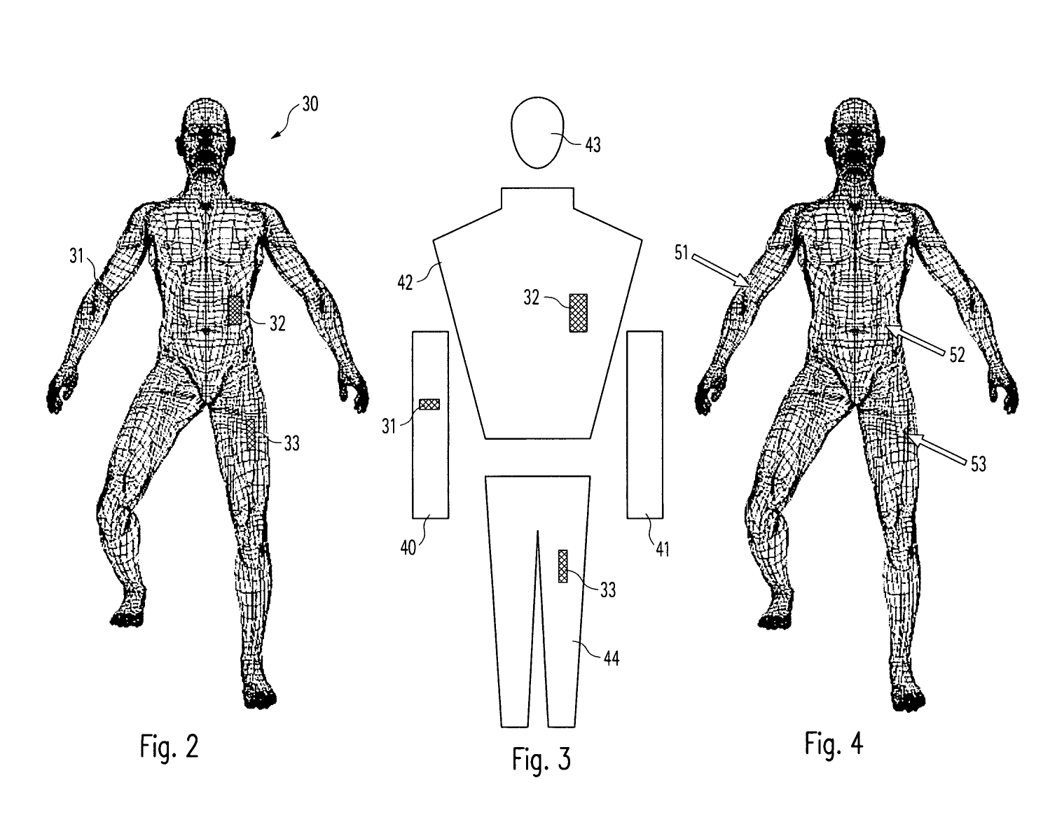

The image with the objects projected onto the avatar can be output to an image-display device 16, preferably a computer screen. An image of this kind is shown in FIG. 2. The cartoon-like avatar 30 displayed in the form of outlines can be seen with the image data projected onto it, wherein an object 31 is identifiable in the arm region, an object 32 is identifiable in the trunk region and an object 33 is identifiable in the thigh region. It is evident here that, as a result of the very abstract presentation of the avatar, the privacy of the observed person 2 is not infringed.

By preference, an even greater abstraction is achieved by generating a wind-off surface of the avatar 30 onto a given geometry, preferably a planar geometry with minimization of the length error and angular error, instead of the avatar 30 in its three-dimensional display. In this context, for example, a flat map, a pattern for virtual clothing or partial projections are appropriate. With the use of virtual clothing, a contribution can be made towards anonymity by segmenting or fragmenting the different body regions.

A presentation of this kind is shown by way of example in FIG. 3. This is in fact not directly a pattern for a virtual clothing, but partial regions which correspond to different body regions. For example, the regions 40 and 41 correspond to the arm regions, the partial region 42 corresponds to the trunk and neck region, the partial region 43 corresponds to the head region and the partial region 44 corresponds to the leg and lumbar region. In each case the projected objects 31, 32 and 33 are evident here, wherein the object 31 comes to be disposed in the partial region 40 of the right arm region, the object 32 in the partial region 42 of the trunk region, and the object 33 in the partial region 44 of the leg region. Although the privacy of the person 2 under observation remains completely protected, because inferences of any kind relating to the individual body parts of the person can no longer be made from the display; it is still unambiguously recognizable by the security personnel, where the detected objects 31-33 are disposed on the body of the person 2 under observation.

For the implementation of this wind-off surface, a wind-off-surface processor 17 (wind-off surface) is provided in the device 1 illustrated schematically in FIG. 1. The wind-off-surface image data generated by the wind-off-surface processor 17 can also be called up as an image on the display device 16.

If the direct display of the objects 31-33 in conjunction with image data of the surrounding bodily parts as presented in FIG. 2 is not desirable because this still does not adequately distort the bodily parts, and, instead, only an abstracted wind-off surface is presented, as visualized by way of example in FIG. 3, then it is meaningful at least to mark the body regions in which the detected objects 31-33 are disposed on the avatar 30. This facilitates subsequent investigations, for example, through a body search of the person under observation.

This marking of the body regions in which the objects 31 to 33 are disposed is illustrated by way of example in FIG. 4. By contrast with FIG. 2, no image data at all are projected onto the avatar; only corresponding body regions are marked, for example, by arrows 51 to 53. In this context, the arrow 51 corresponds to the object 31, the arrow 52 to the object 32 and the arrow 53 to the object 33. For this purpose, a corresponding marking device 18 (pointer avatar) is provided in the exemplary embodiment of FIG. 1. In the display device 16, these markings 51-53 are presented on the avatar 30 as an alternative image.

Moreover, it may be meaningful if the position of the objects 31 to 33 is indicated directly on the person 2 under observation, for example, by a directed light emission, especially by a laser beam 25. The security personnel then know exactly where the object is disposed and can implement, for example, a targeted body search there. For this purpose, with a device illustrated schematically in FIG. 1, a body marker device 19 (pointer person) which converts the image data into body-position data is provided. These body-position data can then be rerouted to a laser controller 20, which, in the exemplary embodiment, controls a corresponding laser 21 and a corresponding motor 22 for positioning the laser beam 25. The laser beam 25 is then directed in a targeted manner to the corresponding body region at which the corresponding object 31 was detected, and generates a light spot there.

As an alternative, it is also possible to output the position of the detected objects 31, 32 and 33 through an acoustic audio signal. For this purpose, the device 1 shown in FIG. 1 comprises a language control device 23 (language controller), which is connected to a loudspeaker 24 or headphones or headset. In the exemplary case, the control personnel can be given a corresponding indication through a language output “an object on the right upper arm”, “an object at the left-hand side of the abdomen” and “an object on the left thigh”.

The output can also be implemented in the form of an image in such a manner that the microwave image of the detected objects 31-33 generated by the microwave scanner is matched over an optical image of the person 2 under observation which is obtained via the camera 6. In this context, the whole body of the person 2 under observation is preferably not shown, but only small details of those body regions in which the objects 31 to 33 have been detected.

Instead of an avatar 30 similar to a body, simpler projection geometries can also be used for the artificial body, for example, a cylinder for partial regions of the body, such as the arms, a truncated cone for the trunk and so on. It is also conceivable to use individual projection geometries for every individual feature image, for example, from the respective, smoothed height profile of the optical data recorded with the camera 6. Any ambiguity in imaging onto the projection geometry is then precluded. However, each individual result image must then also be evaluated interactively within a film sequence.

One advantage with the presentation of the wind-off surface is also that the entire body surface can be presented simultaneously, that is to say, both the front side and the rear side of the person 2 under observation.

In the case of the block-circuit diagram illustrated in FIG. 1, a re-projection processor 26, the output of which is connected to the projection processor 15, is advantageously provided. The re-projection processor 26 is used to re-project the image data projected onto the artificial body, for example, the avatar 30, as required, so that the original image data with the body contours of the person 2 under observation are available. This re-projection is only implemented if security-relevant objects 31-33 have been detected. In this context, it is possible to place the microwave-image data recorded by the microwave-image recording unit 3-4, 7-9 over optical image data which have been recorded by the camera 6. In this case, a re-projection of the location is also sufficient. That is to say, initially, the image information itself need not also be transformed.

To avoid misuse of data, it is meaningful if the projection processor 15 implements an encrypted transformation during the projection, and the re-projection processor 26 uses a re-transformation for the re-projection, which is bijective relative to the transformation implemented by the projection processor 15. In this context, the encryption ensures that the re-transformation is not possible without a knowledge of the key, so that the permission for the re-transformation can be restricted to specially authorized members of the security team.

The invention is not restricted to the exemplary embodiment presented. All of the elements described or illustrated above can be combined with one another as required within the framework of the invention. A combination of the physical-space detection (by means of high frequency (HF) or x-ray radiation (x-ray)) with optical TOF measurement (measurement of the depth profile) as mentioned above is also conceivable. In this context, the TOF from, for example, several perspectives could be used directly to generate the avatar. A further advantage is derived by limiting the target volume. Accordingly, recording and/or calculation time could be saved in the reconstruction of the image data.

1. A method for detecting and displaying image data of at least one object with reference to a human or animal body comprising:
detecting a spatial structure and/or position of the object through a physical space detection, and generating image data of the object on the basis of this detection,
projecting the image data onto an artificial body which represents the human or animal body, and
displaying the object using the image data projected onto the artificial body.

2. The method according to claim 1,
wherein the artificial body is an avatar with a form representing the human or animal body in an abstract manner.

3. The method according to claim 2,
wherein, from the avatar with the object projected on it, a simplified wind-off surface is displayed.

4. The method according to claim 3,
wherein the simplified wind-off surface is a pattern for a virtual clothing and/or that the simplified wind-off surface is segmented into partial regions which correspond to the different regions of the body.

5. The method according to claim 1,
wherein either the object itself or the position of the object on the artificial body is displayed with an image display device.

6. The method according to claim 1,
wherein the position of the object on the human or animal body is displayed especially through a directed light emission, especially through a laser pointer.

7. The method according to claim 1,
wherein the image data projected onto the artificial body are re-projected and displayed on an optical image of the human or animal body.

8. The method according to claim 7,
wherein, in the projection, a transformation is used and in the re-projection, a re-transformation is used which are mutually bijective.

9. The method according to claim 8,
wherein, in the transformation an encryption is used without a knowledge of which the re-transformation is rendered impossible or at least difficult.

10. The method according to claim 1,
wherein for the physical space detection, a microwave scanner using microwave radiation and/or an x-ray scanner using x-ray radiation is used.

11. The method according to claim 1,
wherein the image data are revised through a noise suppression and/or a suppression of low-frequency signal components which are caused by the contour of the human or animal body, and/or through a cartoon-like presentation of outlines and/or flat structures, especially filled contours.

12. A device for detecting and displaying image data of at least one object with reference to a human or animal body, said device comprising:
a detection device for detecting a spatial structure and/or position of the object by a physical space detection and for generating image data of the object on the basis of this detection,
a projection processor for projecting the image data onto an artificial body, which represents the human or animal body,
and a display device for displaying the object using the image data projected onto the artificial body.

13. The device according to claim 12,
wherein the artificial body is an avatar with a form representing the human or animal body in an abstract manner.

14. The device according to claim 13,
wherein a wind-off-surface processor, which generates a simplified wind-off surface from the avatar with object projected on it.

15. The device according to claim 14,
wherein the wind-off-surface processor is formed in such a manner that the simplified wind-off surface provides the pattern of a virtual clothing and/or that the simplified wind-off surface is segmented into partial regions which correspond to the different regions of the body.

16. The device according to claim 12,
wherein the display device provides an image display device, which displays either the object itself or the position of the object on the artificial body.

17. The device according to claim 12,
wherein the display device comprises a body-display device, especially a laser pointer, which displays the position of the object directly on the human or animal body, especially through a directed light emission, especially through a laser beam.

18. The device according to claim 12,
wherein a re-projection processor, which re-projects the image data projected onto the artificial body, wherein the display device displays the re-projected image data on an optical image of the human or animal body detected by a camera.

19. The device according to claim 18,
wherein, in the projection, the projection processor uses a transformation, and in the re-projection, the re-projection processor uses a re-transformation which are mutually bijective.

20. The device according to claim 19,
wherein, in the projection, the projection processor uses an encryption without a knowledge of which the re-transformation is rendered impossible or at least difficult.

21. The device according to claim 12,
wherein the detection device provides a microwave scanner using microwave radiation or an x-ray scanner using x-ray radiation.

22. The device according to claim 12,
wherein a noise suppression processor which subjects the image data to a noise suppression and/or a filter device for the suppression of the low-frequency signal components in the image data which are caused by the contour of the human or animal body, and/or an image abstraction processor for revising the image data to provide a cartoon-like display of outlines and/or flat structures, especially filled contours.
